(19) United States
(12) Patent Application Publication
(10) Pub. No.: US 2021/0251225 A1
(43) Pub. Date: Aug. 19, 2021

(54) DISINFECTANT CLEANING COMPOSITIONS AND METHODS OF USE THEREOF

(71) Applicant: RHODIA OPERATIONS, Aubervilliers (FR)

(72) Inventors: Amit SEHGAL, Potomac, MD (US); Laura GAGE, Lawrenceville, NJ (US); Kamel RAMDANI, Princeton, NJ (US)

(73) Assignee: RHODIA OPERATIONS, Aubervilliers (FR)

(21) Appl. No.: 17/173,234

(22) Filed: Feb. 11, 2021

Related U.S. Application Data
(60) Provisional application No. 62/975,977, filed on Feb. 13, 2020.

(51) Int. Cl. A01N 33/12; A01N 37/36; A01N 37/02; A01N 25/30; A01N 25/10; C11D 3/48; C11D 1/94; C11D 3/30; C11D 11/00

(52) U.S. Cl. CPC A01N 33/12; A01N 37/36; A01N 37/02; A01N 25/30; A01N 25/10; C11D 1/75; C11D 1/94; C11D 3/30; C11D 11/0023; C11D 11/007; C11D 3/48

(57) ABSTRACT

The present disclosure provides a method for killing pathogens on a surface, the method comprising applying a composition to the surface, the composition comprising: at least one quaternary ammonium compound; a polymer comprising one or more types of monomer units selected from cationic monomer units, anionic monomer units, amphoteric monomer units, non-ionic monomer units, and combinations thereof, wherein at least one cationic monomer unit, amphoteric monomer unit or at least one anionic monomer unit is present when the polymer comprises one or more non-ionic monomer units; a surfactant selected from cationic surfactants, amphoteric surfactants, non-ionic surfactants, and combinations thereof; and, optionally, an organic acid, wherein the pH of the composition is less than 5; and the composition achieves at least 0.5 log reduction in the amount of live pathogens on the surface, wherein the pathogens are selected from bacterial spores, fungal spores, non-enveloped viruses and combinations thereof within about 60 minutes, under conditions of standard temperature and pressure.

### CROSS-REFERENCE TO RELATED APPLICATION

The present application claims the benefit of priority under 35 U.S.C. § 119(e) of U.S. Provisional Application Ser. No. 62/975,977, filed on Feb. 13, 2020, the entire disclosure of which is incorporated herein by reference.

### BACKGROUND

Germs such as bacteria, fungi, viruses, and spores are responsible for a plethora of human and animal ills, as well as contamination and spoilage of food, biological and environmental samples. One important strategy used to prevent growth and transmission of germs is treatment of surfaces that serve as a source of unwanted pathogens with disinfecting (e.g. antimicrobial) agents. Surface disinfecting and sanitizing agents are widely used in healthcare, industrial and household environments.

Commonly used disinfectants include oxidizing agents, alcohols, aldehydes, and surfactants. Different types of organisms vary in their response to these substances. As an example, bacterial spores of the genera Bacillus and Clostridium have been widely studied and are considered to be the most resistant of all types of bacteria to disinfectants as well as antiseptics. Clostridium difficile (C. difficile) is a spore-forming, Gram-positive anaerobic bacillus of the human intestine and is thought to be present in 2-5% of the adult population. Bleach-based compositions have been employed for hard surfaces, and have been shown to reduce the environmental burden of C. difficile but can be corrosive. Alcohol-based sanitizers have not generally been effective. In fact, ethanol is sometimes used to store C. difficile spores. While quaternary ammonium compounds have demonstrated bactericidal and fungicidal activity, they have been characterized as not effective against spores or non-enveloped viruses. (See Rutala, W. A. and Weber, D. J. Am. J. of Infection Control 2016, 44, e5 (Table 4)).

There remains a need for disinfecting agents which can be used in household, therapeutic, industrial or agricultural applications, which preferably have broad-spectrum activity and have limited side-effects or toxicity.

### SUMMARY

In certain embodiments are provided methods for killing pathogens on a surface, the methods include a step of applying a composition to the surface, the composition includes at least one quaternary ammonium compound; a polymer that includes one or more types of monomer units selected from cationic monomer units, anionic monomer units, amphoteric monomer units, non-ionic monomer units, and combinations thereof, wherein at least one cationic monomer unit, at least one amphoteric monomer unit or at least one anionic monomer unit is present when the polymer comprises one or more non-ionic monomer units; a surfactant selected from cationic surfactants, amphoteric surfactants, non-ionic surfactants, and combinations thereof; and, optionally, an organic acid, wherein the pH of the composition is less than 5; and the composition achieves at least 0.5 log reduction in the amount of live pathogens on the surface, wherein the pathogens are selected from bacterial spores, fungal spores, non-enveloped viruses and combinations thereof within about 60 minutes, under conditions of standard temperature and pressure.

In an embodiment, the composition achieves at least 3 log reduction in the amount of live pathogens within about 60 minutes, under conditions of standard temperature and pressure.

In an embodiment, the composition achieves at least 3 log reduction in the amount of live pathogens within about 30 minutes, under conditions of standard temperature and pressure.

In an embodiment, the composition achieves at least 3 log reduction in the amount of live pathogens within about 10 minutes, under conditions of standard temperature and pressure.

In an embodiment, the composition further includes at least one germinant in an amount sufficient to initiate germination of bacterial spores present on the surface.

### BRIEF DESCRIPTION OF THE FIGURE

FIG. 1 is the sporulation pH at which the bacillus spores were prepared in Example 1.

### DETAILED DESCRIPTION

The present disclosure relates to methods for killing pathogens on a surface, the method including the step of applying a composition to the surface, the composition including at least one quaternary ammonium compound; a polymer that includes one or more types of monomer units selected from cationic monomer units, anionic monomer units, amphoteric monomer units, non-ionic monomer units, and combinations thereof, wherein at least one cationic monomer unit or at least one amphoteric monomer unit or at least one anionic monomer unit is present when the polymer includes one or more non-ionic monomer units; a surfactant selected from cationic surfactants, amphoteric surfactants, non-ionic surfactants, and combinations thereof; and, optionally, an organic acid, wherein the pH of the composition is less than 5; and the composition achieves at least 0.5 log reduction in the amount of live pathogens on the surface, wherein the pathogens are selected from bacterial spores, fungal spores, non-enveloped viruses within about 60 minutes, under conditions of standard temperature and pressure.

In certain embodiments, the composition is effective against a variety of pathogens, for example, pathogens on a target surface. The term “log reduction” is a mathematical term to show the number of live pathogens killed by contacting the pathogens with a composition of the present disclosure. For example, a “1 log reduction” means that the number of live pathogens is 10 times smaller. A “2 log reduction” means that the number of live pathogens is 100 times smaller. A “3 log reduction” means that the number of live pathogens is 1,000 times smaller. The term “kill,” and grammatical equivalents, means irreversible damage to the structural organization of the cell and rendering the pathogen incapable of reproduction, metabolism and/or growth. As used herein, the term “live” refers to pathogens capable of reproduction, metabolism and/or growth.

In certain embodiments, the compositions achieve at least 0.5 log reduction in the amount of pathogens capable of reproduction, metabolism and/or growth within about 60 minutes (or 30 minutes or 10 minutes or 5 minutes), under conditions of standard temperature and pressure. In certain embodiments, the compositions achieve at least 1 log reduction in the amount of pathogens capable of reproduction, metabolism and/or growth within about 60 minutes (or 30 minutes or 10 minutes or 5 minutes), under conditions of standard temperature and pressure. In certain embodiments, the compositions achieve at least 2 log reduction in the amount of pathogens capable of reproduction, metabolism and/or growth within about 60 minutes (or 30 minutes or 10 minutes or 5 minutes), under conditions of standard temperature and pressure. In certain embodiments, the compositions achieve at least 3 log reduction in the amount of pathogens capable of reproduction, metabolism and/or growth within about 60 minutes (or 30 minutes or 10 minutes or 5 minutes) under conditions of standard temperature and pressure. In certain embodiments, the compositions achieve at least 4 log reduction in the amount of pathogens capable of reproduction, metabolism and/or growth within about 60 minutes (or 30 minutes or 10 minutes or 5 minutes), under conditions of standard temperature and pressure. In certain embodiments, the compositions achieve at least 5 log reduction in the amount of pathogens capable of reproduction, metabolism and/or growth within about 60 minutes (or 30 minutes or 10 minutes or 5 minutes), under conditions of standard temperature and pressure. In certain embodiments, the compositions achieve at least 6 log reduction in the amount of pathogens capable of reproduction, metabolism and/or growth within about 60 minutes (or 30 minutes or 10 minutes or 5 minutes), under conditions of standard temperature and pressure.

The composition may be effective against bacterial spores, and/or fungal spores, and/or non-enveloped viruses. Bacterial spores may include bacteria of the Bacillus or Clostridia genera. Bacteria may include B. subtilis, B. cereus, B. thuringiensis, B. amyloliquefaciens, B. anthracis, C. perfringens, C. difficile, C. septicum, C. botulinum, C. sordellii, C. tetani, C. novyi, or combinations thereof. Non-enveloped viruses may include the families Picornaviridae, Reoviridae, Caliciviridae, Adenoviridae, Papovaviridae, and Parvoviridae. Members of these families include rhinovirus, poliovirus, adenovirus, hepatitis A virus, norovirus, papillomavirus, enterovirus, coxsackievirus, and rotavirus. Examples of fungi include Aspergillus spp., Blastomyces spp., Candida spp., Cladosporium. Coccidioides spp., Cryptococcus spp., Exserohilum, fusarium. Histoplasma spp., Issatchenkia spp., mucormycetes. Pneumocystis spp., ringworm scedosporium. Sporothrix, and Stachybotrys spp.

In an embodiment, the pH of the composition ranges from about 0 to about 5. In another embodiment, the pH of the composition is less than 5. In another embodiment, the pH of the composition ranges from 2 to 4.9. In yet another embodiment, the pH of the composition ranges from 3 to 4.8. In an embodiment, the pH of the composition ranges from 0.5 to 3.

The compositions of the present disclosure include at least one quaternary ammonium compound. In an embodiment, the quaternary ammonium compound is an antimicrobial “quat.” The term “quaternary ammonium compound” or “quat” generally refers to any composition with the following formula:

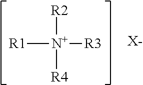

where R1-R4 are alkyl groups that may be alike or different, substituted or unsubstituted, saturated or unsaturated, branched or unbranched, and cyclic or acyclic and may contain ether, ester, or amide linkages; they may be aromatic or substituted aromatic groups. In an embodiment, groups R1, R2, R3, and R4 each have less than a C20 chain length. X⁻is an anionic counterion. The term “anionic counterion” includes any ion that can form a salt with quaternary ammonium. Examples of suitable counterions include halides such as chlorides, bromides, fluorides, and iodides, as well as sulphonates, propionates, methosulphates, saccharinates, ethosulphates, hydroxides, acetates, citrates, phosphates, carbonates, bicarbonates, and nitrates. In an embodiment, the anionic counterion is chloride.

In some embodiments, quaternary ammoniums having carbon chains of less than 20 or C2-C20 are included in compositions of the present disclosure. In other embodiments, quaternary ammoniums having carbon chains of C6-C18, C12-C18, C12-C16 and C6-C10 are included in compositions of the present disclosure. Examples of quaternary ammonium compounds useful in the present disclosure include, but are not limited to, alkyl dimethyl benzyl ammonium chloride, alkyl dimethyl ethylbenzyl ammonium chloride, octyl decyl dimethyl ammonium chloride, dioctyl dimethyl ammonium chloride, and didecyl dimethyl ammonium chloride. A single quaternary ammonium or a combination of more than one quaternary ammonium may be included in compositions of the present disclosure. Further examples of quaternary ammonium compounds useful in the present disclosure include, but are not limited to, benzethonium chloride, ethylbenzyl alkonium chloride, ethyl benzethonium chloride, myristyl trimethyl ammonium chloride, methyl benzethonium chloride, cetalkonium chloride, cetrimonium bromide (CTAB), carnitine, dofanium chloride, tetraethyl ammonium bromide (TEAB), domiphen bromide, benzododecinium bromide, benzoxonium chloride, choline, denatonium, and mixtures thereof.

In some embodiments depending on the nature of the R group, the anion, and the number of quaternary nitrogen atoms present, the antimicrobial quaternary ammonium compounds may be classified into one of the following categories: monoalkyltrimethyl ammonium salts; monoalkyldimethylbenzyl ammonium salts; dialkyldimethyl ammonium salts; heteroaromatic ammonium salts; polysubstituted quaternary ammonium salts; bis-quaternary ammonium salts; and polymeric quaternary ammonium salts. Each category will be discussed herein.

Monoalkyltrimethyl ammonium salts contain one R group that is a long-chain alkyl group, and the remaining R groups are short-chain alkyl groups, such as methyl or ethyl groups. Some non-limiting examples of monoalkyltrimethyl ammonium salts include cetyltrimethylammonium bromide, commercial available under the tradenames Rhodaquat® M242C/29 and Dehyquart® A; alkyltrimethyl ammonium chloride, commercially available as Arquad® 16; alkylaryltrimethyl ammonium chloride; and cetyldimethyl ethylammonium bromide, commercially available as Ammonyx® DME.

Monoalkyldimethylbenzyl ammonium salts contain one R group that is a long-chain alkyl group, a second R group that is a benzyl radical, and the two remaining R groups are short-chain alkyl groups, such as methyl or ethyl groups. Some non-limiting examples of monoalkyldimethylbenzyl ammonium salts include alkyldimethylbenzyl ammonium chlorides, commercially available as Barquat® from Lonza Inc.; and benzethonium chloride, commercially available as Lonzagard®, from Lonza Inc. Additionally, the monoalkyldimethylbenzyl ammonium salts may be substituted. Non-limiting examples of such salts include dodecyldimethyl-3,4-dichlorobenzyl ammonium chloride. Finally, there are mixtures of alkyldimethylbenzyl and alkyldimethyl substituted benzyl (ethylbenzyl) ammonium chlorides commercially available as BTC® 2125M from Stepan Company, and Barquat® 4250 from Lonza Inc. Other examples include N,N-benzyldimethyloctylammonium chloride, N,N-benzyldimethyldecylammonium chloride, N-dodecyl-N-benzyl-N,N-dimethylammonium chloride, N-tetradecyl-N-benzyl-N,N-dimethylammonium chloride, N-hexadecyl-N,N-dimethyl-N-benzylammonium chloride, N,N-dimethyl N-benzyl N-octadecyl ammonium chloride.

Dialkyldimethyl ammonium salts contain two R groups that are long-chain alkyl groups, and the remaining R groups are short-chain alkyl groups, such as methyl groups. Some non-limiting examples of dialkyldimethyl ammonium salts include didecyldimethyl ammonium halides, commercially available as Bardac® 22 from Lonza Inc.; didecyl dimethyl ammonium chloride commercially available as Bardac® 2250 from Lonza Inc.; dioctyl dimethyl ammonium chloride, commercially available as Bardac® LF and Bardac® LF-80 from Lonza Inc.; and octyl decyl dimethyl ammonium chloride sold as a mixture with didecyl and dioctyl dimethyl ammonium chlorides, commercially available as Bardac® 2050 and 2080 from Lonza Inc.

Heteroaromatic ammonium salts contain one R group that is a long-chain alkyl group, and the remaining R groups are provided by some aromatic system. Accordingly, the quaternary nitrogen to which the R groups are attached is part of an aromatic system such as pyridine, quinoline, or isoquinoline. Some non-limiting examples of heteroaromatic ammonium salts include cetylpyridinium halide, commercially available as Sumquat® 6060/CPC from Zeeland Chemical Inc.; 1-[3-chloroalkyl]-3,5,7-triaza-1-azoniaadamantane, commercially available as Dowicil® 200 from The Dow Chemical Company; and alkyl-isoquinolinium bromide.

Polysubstituted quaternary ammonium salts are a monoalkyltrimethyl ammonium salt, monoalkyldimethylbenzyl ammonium salt, dialkyldimethyl ammonium salt, or heteroaromatic ammonium salt wherein the anion portion of the molecule is a large, high-molecular weight (MW) organic ion. Some non-limiting examples of polysubstituted quaternary ammonium salts include alkyldimethyl benzyl ammonium saccharinate, and dimethylethylbenzyl ammonium cyclohexylsulfamate.

In an embodiment, bis-quaternary ammonium salts may be used, that contain two symmetric quaternary ammonium moieties having the general formula:

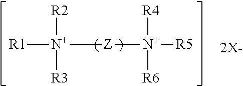

where the R groups may be long or short chain alkyl, a benzyl radical or provided by an aromatic system. Z is a carbon-hydrogen chain attached to each quaternary nitrogen. Some non-limiting examples of bis-quaternary ammonium salts include 1,10-bis(2-methyl-4-aminoquinolinium chloride)-decane; and 1,6-bis[1-methyl-3-(2,2,6-trimethyl cyclohexyl)-propyldimethylammonium chloride] hexane or triclobi sonium chloride. In another embodiment, polymeric quaternary ammonium compounds (>Bis quaternary ammonium salts) are used.

In an embodiment, the quaternary ammonium compound is a medium to long chain alkyl R group, such as from 8 carbons to about 20 carbons, from 8 carbons to about 18 carbons, from about 10 to about 18 carbons, and from about 12 to about 16 carbons, and providing a soluble and good antimicrobial agent.

In an embodiment, the quaternary ammonium compound is a short di-alkyl chain quaternary ammonium compound having an R group, such as from 2 carbons to about 12 carbons, from 3 carbons to about 12 carbons, or from 6 carbons to about 12 carbons.

The composition may include from about 100 to about 50,000 ppm of one or more quaternary ammonium compounds. In various embodiments, the composition includes from about 500 to about 20,000 ppm; from about 500 to about 10,000 ppm; from about 100 to about 500 ppm; or from about 500 to about 5000 ppm of one or more quaternary ammonium compounds.

Polymers suitable for use in compositions of the present disclosure include polymers having: one or more types of monomer units selected from cationic monomer units, anionic monomer units, amphoteric monomer units, non-ionic monomer units, and combinations thereof, wherein at least one cationic monomer unit, at least one amphoteric monomer unit, or at least one anionic monomer unit is present when the polymer comprises one or more non-ionic monomer units. In an embodiment, the polymer includes only cationic monomer units. In another embodiment, the polymer includes only anionic monomer units. In one embodiment, the polymer includes its homopolymer, copolymer, terpolymer, block copolymer, random polymer, linear polymer, comb polymer or branched polymer. The polymers can be synthetic or natural or combinations thereof.

In an embodiment, the composition includes: at least one quaternary ammonium compound; a cationic polysaccharide derived from a natural source; an organic acid; and a surfactant selected from cationic surfactants, amphoteric surfactants, nonionic surfactants, and combinations thereof.

In an embodiment the cationic monomer includes an ammonium group of formula —NR3+, wherein R, which is identical or different, represents a hydrogen atom, an alkyl group comprising 1 to 10 carbon atoms, or a benzyl group, optionally carrying a hydroxyl group, and comprise an anion (counter-ion). Examples of anionic counter-ions are halides such as chloride and bromides, sulphates, hydrosulphates, alkylsulphates (for example comprising 1 to 6 carbon atoms), sulfonates, phosphates, nitrates, citrates, carbonates, bicarbonates, formates, and acetates.

Examples of cationic monomers include, but are not limited to:

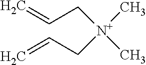

Diallyldimethylammonium halides such as diallyldimethylammonium chloride (DADMAC) or the corresponding bromide. Alternatively, the counter ion may be sulphate, nitrate or phosphate. Similar momomer units, such as those in which one or more of the CH₃ groups is replaced by a C_{2 to 12} for example a C_{2 to 6} alkyl group or one or more of the CH₂ groups is replaced by an alkyl group having from 2 to 12, for example from 2 to 6 carbon atoms may be used. In other words, other similar commercially available monomers or polymers containing such monomers may be used.

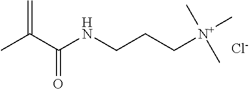

N,N,N-trimethyl-3-((2-methyl-1-oxo-2-propenyl)amino)-1-propanaminium halides, such as the chloride (MAPTAC, also known as methacryl-amido(propyl)-trimethyl ammonium chloride).

Additional examples of cationic monomers include, but are not limited to:
1. aminoalkyl (meth)acrylates, aminoalkyl (meth)acrylamides,
2. monomers, including particularly (meth)acrylates, and (meth)acrylamides derivatives, comprising at least one secondary, tertiary or quaternary amine function, or a heterocyclic group containing a nitrogen atom, vinylamine or ethylenimine;
3. diallyldialkyl ammonium salts;
4. their mixtures, their salts, and macromonomers deriving from therefrom;
5. dimethylaminoethyl (meth)acrylate, dimethylaminopropyl (meth)acrylate, ditertiobutylaminoethyl (meth)acrylate, dimethylaminomethyl (meth)acrylamide, dimethylaminopropyl (meth)acrylamide;
6. ethylenimine, vinylamine, 2-vinylpyridine, 4-vinylpyridine;
7. trimethylammonium ethyl (meth)acrylate chloride, trimethylammonium ethyl (meth)acrylate methyl sulphate, dimethylammonium ethyl (meth)acrylate benzyl chloride, 4-benzoylbenzyl dimethylammonium ethyl acrylate chloride, trimethyl ammonium ethyl (meth)acrylamido (also called 2-(acryloxy)ethyltrimethylammonium, TMAEAMS) chloride, trimethylammonium ethyl (meth)acrylate (also called 2-(acryloxy)ethyltrimethylammonium, TMAEAMS) methyl sulphate, trimethyl ammonium propyl (meth)acrylamido chloride, vinylbenzyl trimethyl ammonium chloride,
8. diallyldimethyl ammonium chloride,
9. monomers having the following formula A(II):

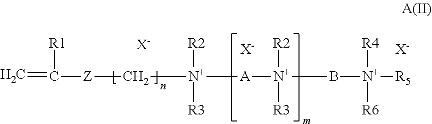

wherein R₁ is a hydrogen atom or a methyl or ethyl group; R₂, R₃, R₄, R₅ and R₆, which are identical or different, are linear or branched C₁-C₆, preferably C₁-C₄, alkyl, hydroxyalkyl or aminoalkyl groups; m is an integer from 0 to 10, for example 1; n is an integer from 1 to 6, preferably 2 to 4; Z represents a —C(O)O— or —C(O)NH— group or an oxygen atom; A represents a (CH₂)ₚ group, p being an integer from 1 to 6, preferably from 2 to 4; B represents a linear or branched C₂-C₁₂, typically C₃-C₆, polymethylene chain optionally interrupted by one or more heteroatoms or heterogroups, in particular 0 or NH, and optionally substituted by one or more hydroxyl or amino groups, preferably hydroxyl groups; X, which are identical or different, represent counterions, and their mixtures, and macromonomers deriving therefrom.

Other cationic monomers include compounds of general formula A(I):

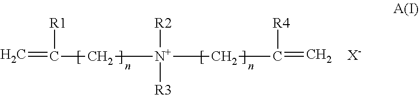

in which: R₁ and R₄, independently of each other, represent a hydrogen atom or a linear or branched C₁-C₆ alkyl group; R₂ and R₃, independently of each other, represent an alkyl, hydroxyalkyl or aminoalkyl group in which the alkyl group is a linear or branched C₁-C₆ chain, preferably a methyl group; n and m are integers between 1 and 3; X, which may be identical or different, represent counterions which are compatible with the water-soluble or water-dispersible nature of the polymer. In one embodiment, X is selected from the group of halide anions, sulfate anions, hydrogen sulfate anions, phosphate anions, nitrate anions, citrate anions, formate anions, or acetate anions.

The polymers used in the present invention may have a polyampholyte structure such that the charge and surface adsorption are determined by pH. In an embodiment, the polymer is an acrylic acid amine-functional polymer. Examples of suitable hydrophilic polymers are described in U.S. Pat. Nos. 6,569,261, 6,593,288, 6,703,358 and 6,767,410, the disclosure of these documents is incorporated herein by reference. These documents describe water-soluble or water-dispersible copolymers including, in the form of polymerized units, (1) at least one amine-functional monomer, (2) at least one hydrophilic monomer with an acidic nature and (3) optionally at least one neutral hydrophilic monomer having an ethylenic unsaturation. The copolymers include quaternized ammonium acrylamide acid copolymers.

Examples of the anionic monomer include, but are not limited to, acrylic acid, methacrylic acid, α-ethacrylic acid, β,β-dimethacrylic acid, methylenemalonic acid, vinylacetic acid, allylacetic acid, ethylideneacetic acid, propylideneacetic acid, crotonic acid, maleic acid, fumaric acid, itaconic acid, citraconic acid, mesaconic acid, N-methacryloylalanine, N-acryloylhydroxyglycine, sulfopropyl acrylate, sulfoethyl acrylate, sulfoethyl methacrylate, sulfoethyl methacrylate, styrenesulfonic acid, vinylsulfonic acid, vinylphosphonic acid, phosphoethyl acrylate, phosphonoethyl acrylate, phosphopropyl acrylate, phosphonopropyl acrylate, phosphoethyl methacrylate, phosphonoethyl methacrylate, phosphopropyl methacrylate and phosphonopropyl methacrylate, and the ammonium and alkali metal salts of these acids.

Examples of the non-ionic monomer include, but are not limited to, 2-(Dimethylamino)ethyl methacrylate (DMAEMA),

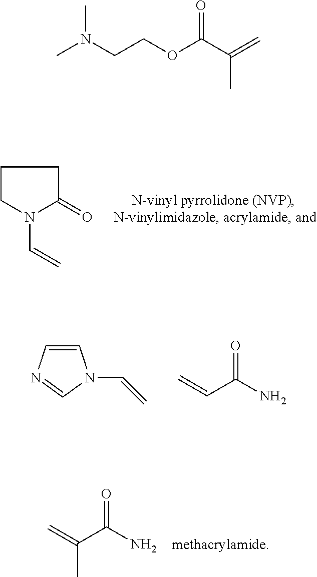

Other examples of non-ionic monomers may include, but are not limited to, alkyl esters or amides of acidic monomers such as acrylic acid, methacrylic acid, α-ethacrylic acid, β,β-dimethacrylic acid, methylenemalonic acid, vinylacetic acid, allylacetic acid, ethylideneacetic acid, propylideneacetic acid, crotonic acid, maleic acid, fumaric acid, itaconic acid, citraconic acid, or mesaconic acid.

In another embodiment, the polymer may include amphoteric monomers or combinations thereof including, but not limited to carboxy-betaines or sulfo-betaines.

An example of a polymer suitable for use in the composition of the present disclosure is a polymer comprising, consisting of or consisting essentially of DMAEMA, MAPTAC and methylacrylic acid.

Suitable polymers include those sold under the trade name Mirapol®, for example as Mirapol® Surf-SHO, Mirapol® Surf-S110, Mirapol® HSC-310, Mirapol® CP-412, Mirapol® Surf-5200, Mirapol® Surf-5550 or Mirapol® Surf-5500 available from Solvay, Novecare.

Other suitable polymers include polymers comprising, consisting of or consisting essentially of DADMAC and acrylamide, such as those sold under the trade name Polyquat® 7 or PQ7 from Surfacare or under the trade name Merquat® S from Lubrizol. Other suitable polymers include polymers comprising, consisting of or consisting essentially of DADMAC and methacrylamide and/or, acrylic acid or methacrylic acid.

Polymers comprising, consisting of or consisting essentially of MAPTAC and acrylamide or methacrylamide are also suitable for use in the composition of the present disclosure. Also suitable are polymers comprising, consisting of or consisting essentially of MAPTAC and vinyl pyrrolidone, such as Polyquat® 28. Suitable polymers include those sold under the trade names Polyquat® Pro. (which is polyquat 28 plus silicone) and Polyquat® Ampo 140 from BASF.

Other suitable polymers include polymers comprising, consisting of or consisting essentially of MAPTAC and acrylic acid or methacrylic acid, such as those sold under the trade name Polyquat® Ampho, eg Polyquat® Ampho 149.

Polymers comprising, consisting of or consisting essentially of DMAEMA and vinylpyrrolidone are suitable for use in the composition of the present disclosure. An example of such a polymer is sold under the name PQ11 by BRB International.

Other suitable polymers include polymers comprising, consisting of or consisting essentially of DMAEMA and acrylamide, such as the polymer sold under the trade name Polyquat® 5. Other polymers may also include polycondensation products such as Poly [bis(2-chloroethyl) ether-alt-1,3-bis [3-(dimethylamino)propyl]urea] also known as Polyquaternium 2.

In an embodiment, the molecular weight of the polymer ranges from about 130,000 g/mol to about 2 million g/mol.

In an embodiment, the amount of polymer in the composition ranges from about 200 ppm to about 4,000 ppm.

In an embodiment, the polymer is guar. Guars are polysaccharides composed of the sugars galactose and mannose. The backbone is a linear chain of β 1,4-linked mannose residues to which galactose residues are 1,6-linked at every second mannose, forming short side-branches.

Within the context of the present disclosure, the cationic guars are cationic derivatives of guars.

In the case of the cationic polysaccharides, such as the cationic guars, the cationic group may be a quaternary ammonium group bearing 3 radicals, which may be identical or different, preferably chosen from hydrogen, alkyl, hydroxyalkyl, epoxyalkyl, alkenyl, or aryl, preferably containing 1 to 22 carbon atoms, more particularly 1 to 14 and advantageously 1 to 3 carbon atoms. The counterion is generally a halogen. One example of the halogen is chlorine.

Examples of the quaternary ammonium salts include: 3-chloro-2-hydroxypropyl trimethyl ammonium chloride (CHPTMAC), 2,3-epoxypropyl trimethyl ammonium chloride (EPTAC), diallyldimethyl ammonium chloride (DMDAAC), vinylbenzene trimethyl ammonium chloride, trimethylammonium ethyl metacrylate chloride, methacrylamidopropyltrimethyl ammonium chloride (MAPTAC), and tetraalkylammonium chloride.

One example of the cationic functional group in the cationic polysaccharides is trimethylamino(2-hydroxyl)propyl, with a counter ion. Various counter ions can be utilized, including but not limited to halides, such as chloride, fluoride, bromide, and iodide, sulfate, methylsulfate, and mixtures thereof.

In an embodiment, the cationic guars of the present disclosure are chosen from: cationic hydroxyalkyl guars, such as cationic hydroxyethyl guar (HE guar), cationic hydroxypropyl guar (HP guar), cationic hydroxybutyl guar (HB guar); and cationic carboxylalkyl guars including cationic carboxymethyl guar (CM guar), cationic carboxylpropyl guar (CP guar), cationic carboxybutyl guar (CB guar), and carboxymethylhydroxypropyl guar (CMHP guar).

In an embodiment, the cationic guars of the present disclosure are guars hydroxypropyltrimonium chloride or hydroxypropyl guar hydroxypropyltrimonium chloride.

In an embodiment, the cationic polysaccharide is a blend of cationic guar and one or more film forming water soluble polymers. In an embodiment, the film forming polymers are selected from polyvinylalcohol (PVA), polyvinylpyrrolidone (PVP), copolymers comprising PVP, chitosan, ionic polymers (e.g., anionic polymers comprising carboxylic or sulfonic acid groups and their salts where the protons are substituted, by lithium, sodium, potassium, etc.), polyacrylamides.

In another embodiment, the cationic polysaccharide is a depolymerized guar. In this embodiment, the cationic guar may be prepared by depolymerizing cationically modified guars that have high molecular weight, so as to “split” the guar polymers to desired sizes. It is appreciated that the cationic guar of the present disclosure may also be prepared by depolymerization of natural guars, followed by cationization reactions to provide the polymers with cationic functionality. Various depolymerization methods are well known in the art and may be used, such as treatment by using peroxo compound (e.g., hydrogen peroxide) and irradiation. Examples of such methods are disclosed in U.S. Pat. Nos. 4,547,571, 6,383,344 and 7,259,192. The cationization of guars can be easily made by a skilled person using methods commonly known in the art. Alternatively, low molecular weight guars can be obtained by harvesting guar beans which are still at an early developmental stage such that the harvested guar beans contain low molecular weight natural guar gums. Then the guar gums may be subject to cationization to provide them with cationic functionality.

Among the cationic guar derivatives that may be mentioned are guar hydroxypropyl trimonium chloride (INCI name), for example Jaguar® C13S, C14S, or C17, Jaguar® Excel and Jaguar® C 2000 sold by Solvay or hydroxypropyl guar hydroxypropyl trimonium chloride (INCI name), for example Jaguar® C162 sold by Solvay.

In one embodiment the cationic polysaccharide is cationic cellulose. In an embodiment, the cationic cellulose is cellulose ether (e.g. hydroxyethyl cellulose and hydroxymethyl cellulose). Examples of cellulose ethers are provided in U.S. Pat. No. 6,833,347.

Cationic celluloses that could be used in the compositions of the present disclosure are celluloses modified by quaternary ammonium cationic group. In an embodiment, the quaternary ammonium group carries three radicals which are identical or different and are selected from hydrogen, alkyl radical from 1 to 10 carbon atoms (e.g. from 1 to 6 carbon atoms; from 1 to 3 carbon atoms), aryl, those three radicals being identical or different. In an embodiment, the quaternary ammonium groups are selected from trialkylammonium groups (e.g. trimethylammonium, triethylammonium, tributylammonium, aryldialkylammonium, benzyldimethylammonium) and ammonium radicals in which the nitrogen atom is a member of a cyclic structure (e.g. pyridinium and imidazoline), each in combination with a counter ion. In and embodiment, the counter ion of the quaternary ammonium group is a halogen (e.g. a chloride ion, a bromide ion or an iodide ion).

The cationic substituent on the cationic starch is the same that those described above for the cationic guar and the cationic cellulose.

In an embodiment, the cationic polysaccharide is derived from an amphoteric polysaccharide that is cationic at a lower pH. In an embodiment, suitable amphoteric polysaccharides include polysaccharide derivatives containing both a cationic and an anionic substituent. The amphoteric polysaccharides are derivatized or modified to contain a cationic group or substituent. The substituted polysaccharides are formed by the derivatization of the hydroxyl functionality of the polysaccharide. The cationic group may be an amino, ammonium, imino, sulfonium or phosphonium group. Such cationic derivatives include those containing nitrogen containing groups comprising primary, secondary, tertiary and quaternary amines and sulfonium and phosphonium groups attached through either ether or ester linkages. In an embodiment, the cationic derivatives comprise tertiary amino and quaternary ammonium ether groups.

The Degree of Substitution (DS) of cationic polysaccharides is the average number of hydroxyl groups substituted per sugar unit. DS may notably be determined by titration.

According to one aspect of the present disclosure, the DS of the cationic polysaccharides is in the range of 0.1 to 1, preferably, from 0.13 to 1, more preferably, from 0.15 to 1, even more preferably, from 0.16 to 0.3.

The Charge Density (CD) of cationic polysaccharides refers to the ratio of the number of positive charges on a monomeric unit of which a polymer is comprised to the molecular weight of said monomeric unit.

According to one aspect of the present disclosure, the charge density of the cationic polysaccharides is in the range of 0.5 to 3 (meq/gm), preferably, 0.8 to 2 (meq/gm), more preferably, 0.8 to 1.6 (meq/gm), particularly 0.9 to 1.4 (meq/gm).

The cationic polysaccharides may have an average Molecular Weight (Mw) of between about 100,000 daltons and 3,500,000 daltons, preferably between about 500,000 daltons and 3,500,000 daltons, more preferably between 1,500,000 daltons and 3,500,000 daltons.

In an embodiment, the amount of cationic polysaccharide in the composition ranges from about 200 ppm to about 5,000 ppm.

Compositions of the present disclosure optionally include one or more organic acids. In an embodiment, the organic acid is selected from citric, malic, maleic, malonic, oxalic, glutaric, succinic, adipic, lactic, glycolic, fumaric, acetic, benzoic, propionic, sorbic, tartaric, dipicolinic, pyridine 2,6-dicarboxylic, itaconic, glutamic acids formic and mixtures of one or more such organic acids. In another embodiment, the organic acids may be multifunctional organic acids. In another embodiment, the counterion acid may be polymeric acid, such as, for example, poly(acrylic acid) or other polycarboxylic acids (e.g. maleic anhydride, methacrylic acid, etc.) or homopolymers or copolymers (e.g. methyl methacrylate, butyl acrylate, etc.) thereof, such as those in the Rhodoline® series available from Solvay. The composition may include from 500 to 7,000 ppm of one or more organic acids.

In compositions of the present disclosure, the surfactant is selected from cationic surfactants, amphoteric surfactants, non-ionic surfactants, and combinations thereof. Cationic surfactants are surfactants that dissolve in water to result in a net cationic charge. In an embodiment, when present, the cationic surfactant is selected from cationic amine oxides, cationic betaines, propionates, amphoacetates and combinations thereof. Amine oxides, propionates, amphoacetates and betaines are cationic in the acidic pH conditions of the present disclosure. In an embodiment, the propionate is selected from cationic C8-C22 propionates and salts thereof. In another embodiment, the cationic C8-C22 propionate is selected from alkyl ampho(di)propionate, alkyl aminopropionates, alkyl amphopropionates, salts thereof, and combinations thereof. In an embodiment the cationic amphoacetate is selected from amphoacetates according to the following formula:

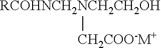

and diamphoacetates according to the following formula:

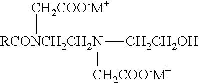

where R is an aliphatic group of 8 to 18 carbon atoms, and M is a cation such as sodium, potassium, ammonium, or substituted ammonium. Sodium lauroamphoacetate, sodium cocoamphoacetate, disodium lauroamphoacetate, and disodium cocoamphodiacetate are preferred in some embodiments.

In another embodiment, the cationic surfactants include surfactants, co-surfactants or pseudo surfactants which have partial cationic nature under low pH conditions, including ethoxylated alkyl amines, alkyl amines, and fatty imidazolines.

In an embodiment, the betaine is selected from cationic C8-C22 betaines and salts thereof. In a further embodiment, the cationic C8-C22 betaine is selected from alkyl dimethylbetaines, alkylamidopropyl betaines, alkylampho(di)acetates, salts thereof, and combinations thereof. Where reference is made herein to “salts thereof” for cationic surfactants, these may be any suitable salts. In one embodiment the salt is a salt based on a monovalent cation, such as Na, K, or NH₄. In one embodiment, the salt is a salt based on an alkali metal, e.g. Na or K. The use of alternative salts, e.g. alkali earth metal salts such as Ca and Mg could also be contemplated; however the solubility of the product would need to be borne in mind when using such salts.

Amphoteric surfactants contain both a basic and an acidic hydrophilic group and an organic hydrophobic group. In an embodiment, when present, the amphoteric surfactant is selected from sultaines, taurates, betaines, and combinations thereof. In an embodiment, the composition includes a combination of one or more cationic and amphoteric surfactants.

In an embodiment, the non-ionic surfactant(s) is/are selected from the group consisting of non-ionic surfactants with a delocalized electronic structure having an HLB value less than 9. In an embodiment, the non-ionic surfactant(s) is/are selected from the group consisting of non-ionic surfactants with a delocalized electronic structure having an HLB value less than 8. In an embodiment, the non-ionic surfactant(s) is/are selected from the group consisting of non-ionic surfactants with a delocalized electronic structure having an HLB value less than 7. In an embodiment, the non-ionic surfactants possess a combination of different HLB values. In an embodiment, the non-ionic surfactant is selected from alcohol ethoxylates. In an embodiment, the low HLB non-ionic surfactant with a delocalized electronic structure that has moderate to poor water solubility is selected from the group consisting of tristyrylphenol ethoxylates, terpene alkoxylates, alkanolamides, and combinations thereof. In an embodiment, the low HLB non-ionic surfactant with a delocalized electronic structure that has moderate to poor water solubility is selected from the group consisting of amine surfactants. In an embodiment, the non-ionic surfactant is a tristyrylphenol ethoxylate with a low degree of ethoxylation (e.g. less than ten or preferably less than eight ethylene oxide (EO) moieties).

In addition to the components described herein, the composition may also include a polar carrier solvent (e.g. water), a chelating agent, fragrance, preservative, dye, corrosion inhibitor, builder, cleansing solvent and other components known to be useful in disinfectant compositions.

In a further aspect, the composition may also include a bacterial spore germinant. The inclusion of a spore germinant causes exposed bacterial spores to germinate into the vegetative state and therefore be more susceptible to the action of the components that kill the pathogens (e.g. spores). Examples of suitable spore germinants which may be used in the compositions of the present disclosure include lactate, pyruvate, cholic acids, bile acids, sodium bicarbonate, glucose, sodium thioglycolate, sodium bicarbonate, dipicolinic acid and derivatives and combinations thereof.

In an embodiment, the composition further includes an additive selected from ethanolamines, amino acids, thio-alcohols, thiolamines, and combinations thereof.

The compositions according to the present disclosure include both disinfectant cleaning compositions and concentrates which only differ in the relative proportion of water to that of the other constituents. The concentrate can be used without dilution (concentrate:water 1:0) to extremely dilute dilutions (e.g., 1:10,000). In an embodiment, a range of dilution is from about 1:1 to about 1:1,000. In another embodiment, a range of dilution is from about 1:1 to about 1:500. In yet another embodiment, a range of dilution is from about 1:10 to about 1:128.

The composition may be applied to a surface by any method, including methods conducted by hand and methods conducted by machine and combinations thereof. For example, composition may be applied by spraying (pump, aerosol, pressure, electrostatic spray apparatus etc.), pouring, spreading, metering (for example, with a rod or bar), mopping, wiping, brushing, dipping, mechanical application, other application methods, or combination thereof.

In an embodiment, the method further includes the step of treating the surface using a technique selected from ultrasonication, filtration, UV irradiation, heating, freezing, drying, and combinations thereof.

In an embodiment, compositions of the present disclosure are suited for use in a “spray and wipe” application. In such an application, the user generally applies an effective amount of the cleaning composition using the pump and within a few moments thereafter, wipes off the treated area with a rag, towel, or sponge, usually a disposable paper towel or sponge.

Compositions of the present disclosure, whether as described herein or in a concentrate or super concentrate form, can also be applied to a hard surface by using a wet wipe. The wipe can be of a woven or non-woven nature. Fabric substrates can include non-woven or woven pouches, sponges, in the form of abrasive or non-abrasive cleaning pads. Such fabrics are known commercially in this field and are often referred to as wipes. Such substrates can be resin bonded, hydroentangled, thermally bonded, meltblown, needlepunched, or any combination of the former.

The non-woven fabrics may be a combination of wood pulp fibers and textile length synthetic fibers formed by well-known dry-form or wet-lay processes. Synthetic fibers such as rayon, nylon, orlon and polyester as well as blends thereof can be employed. The wood pulp fibers should comprise about 30 to about 60 percent by weight of the non-woven fabric, preferably about 55 to about 60 percent by weight, the remainder being synthetic fibers. The wood pulp fibers provide for absorbency, abrasion and soil retention whereas the synthetic fibers provide for substrate strength and resiliency.

The compositions of the present disclosure are absorbed onto the wipe to form a saturated wipe. The wipe can then be sealed individually in a pouch which can then be opened when needed or a multitude of wipes can be placed in a container for use on an as needed basis. The container, when closed, sufficiently sealed to prevent evaporation of any components from the compositions.

The composition of the present disclosure may be put to use by application any substrate. Some suitable substrates include, for example, countertops, mirrors, sinks, toilets, light switches, doorknobs, walls, floors, ceilings, partitions, railings, computer screens, keyboards, instruments, etc. Suitable substrates may be found in various settings including, for example, food preparation areas, households, industrial settings, architectural settings, medical settings, sinks, toilets, etc. Substrates may be made of any material; some suitable substrate compositions include, for example, plastic (including, for example, laminates and wall coverings), Formica, metal, glass, ceramic tile, finished or unfinished wood, etc. In another embodiment, the surface may include porous materials such as cement, brick, composite, foams, paper (such as, for example, wallpaper) or fabric.

Besides the above method of application of the formulation to provide instant kill in seconds or minutes, this application also provides a longer lasting disinfection and cleaning of treated surfaces. The residual disinfection compositions achieve microorganism (e.g. bacterial, viral, or fungal) kill of at least 95% or greater, (e.g. 99.9% kill), for 12 to 24 hours obviating the need for repeated treatment. Suitable techniques for assessing the effectiveness of compositions of the present disclosure include U.S. and European standard methods.

In order to substantiate 24 hour long-term sanitization claims with the United States Environmental Protection Agency (EPA), compositions are evaluated with the residual self-sanitization (RSS) method, EPA Protocol #01-1A. The EPA Protocol #01-1A can be found on the EPA website (https://www.epa.gov/sites/production/files/2015-09/documents/cloroxpcol_final.pdf). For validating longer term disinfection, all extant test protocols emulate the maximum amount of recontamination and abrasion by touching and wiping anticipated before reapplication, typically a 24 hour period. An intermediate protocol with approximately half the level abrasion and re-soiling challenge to a surface is presented here as the “RSS-12h” test protocol.

To address the need for a Standard European Test Method by which residual antimicrobial activity can be measured and assessed, the British Standard Institute has recently published BSI-PAS-2424 titled: “Quantitative surface test for the evaluation of residual antimicrobial (bactericidal and/or yeasticidal) efficacy of liquid chemical disinfectants on hard non-porous surfaces—Test method”. Most methods involving testing of antimicrobial efficacy involve applying a product to a surface and leaving it for a period of time before challenging with micro-organisms. The limitation of such methods is that the surface remains undisturbed following application. In reality, a Lancaster University report: “Cleaning Behaviours in the Home” based on consumer research showed that in domestic or workplace environment, once a product has been applied to a surface, the surface is continually exposed to abrasion such as touching and wiping. This results in re-contamination of the surface before reapplication of a product, typically every 24 h. The test method BSI PAS 2424 was designed to reflect actual conditions in which a product is designed to be used.

The EPA-RSS, RSS-12h and the BSI-PAS 2424 methods all attempt to emulate efficacy of a long-lasting disinfectant by incorporating wet and dry abrasion cycles into the testing protocol. Besides the overt similarities between the test methods there are some significant differences between RSS and PAS2424 methods.

1. Microorganisms: The number of microorganisms and types tested by the two methods are different and are listed below. EPA-RSS list is much shorter (e.g. gram+ve and gram −ve bacteria), while PAS-2424 includes four bacteria and one yeast strain.
2. The weights used for the abrasion testing are very different for the two methods besides the application geometry. The normal force applied in the EPA-RSS test method including the weight boats is 1084 g±0.2 g which is 5 times greater than the normal force applied in the BSI PAS 2424 method 210 g±2 g.
3. Abrasion cycles: The EPA-RSS method uses 6 wear cycles compared to 3 wear cycles for the BSI-PAS 2424 as in the RSS-12h test protocol.

In an embodiment, a film formed from the composition kills at least 99.9% (e.g. log 3 reduction) of microorganisms according to the residual self-sanitizing (RSS) activity test (EPA Protocol #01-1A). In an embodiment, a film formed from the composition kills at least 99.9% (e.g. log 3 reduction) of gram-positive bacteria and gram-negative bacteria according to the residual self-sanitizing (RSS) activity test (EPA Protocol #01-1A).

Long lasting disinfection claims are substantiated by the RSS test, which challenges the applied composition by subjecting it to recontamination (re-inoculation with microorganisms) and abrasion (wear cycles). An intermediate test protocol, with approximately half the number of re-inoculations and wear cycles (“RSS-12h”) is used to predict disinfection that is durable up to 12 hours before reapplication of the test product. This procedure requires preparation of the test bacterial (microbial) culture over the first week (see EPA Protocol #01-1A) followed by testing in week 2.

The testing involves inoculating the surface with bacteria, followed by application of the product on the substrate and allowing it to dry. The substrate may be glass, polycarbonate, or steel. This substrate is then subjected to an abrasion—re-inoculation regime of 3 “wear cycles”. The abrasion is conducted with a 1084 gwt. rectangular steel block covered with a cloth with an underlying thin polyurethane-foam layer. Each wear cycle is composed of a “dry” abrasion and a “wet” abrasion, the latter with the cloth cover having been wet with a mist of water using a Preval® sprayer. Each abrasion (dry/wet) is characterized by a back and forth motion of the block across the test substrate. Each abrasion cycle is followed by re-inoculation the surface with a bacterial culture. The RSS-12h involves a 3-abrasion cycle/3-inoculations test as compared to the full RSS test that outlines a 6-abrasion cycle/6-inoculation test regimen. All other details of the test method are as outlined in the EPA Protocol #01-1A.

The test substrate is allowed to dry overnight and then finally inoculated again (sanitizer test) for 5 minutes, followed by neutralization of the entire substrate. Surviving bacteria is then harvested off the surface and cultured with serial dilutions on agar plates, allowing colony formation over 24-48 hours. Surviving bacteria are then counted as the number of colonies. The difference in bacterial count inoculated and surviving bacteria results in an efficacy evaluation in percent kill (e.g. 99.9% kill) or log-reduction (e.g. 3-log reduction) on a logarithmic scale. The bacteria in this test may be substituted for other microorganisms such as fungi or viruses.

The composition of the present disclosure is a liquid formulation. It is contemplated that one preferred method of making use of the composition of the present disclosure is to apply a layer of the composition to a substrate and dry the composition or allow it to dry. The act of applying a layer of the composition to a substrate and then drying it or allowing it to dry is known herein as “treating” the substrate. It is contemplated that, as the solvent evaporates, the composition will form a film on the substrate. The dried layer of the composition is known herein as “a film.”

Also presented are methods of providing a surface with residual antimicrobial action that include the step of applying a composition of the present disclosure to the surface. The present disclosure also provides a substrate with residual antimicrobial action comprising a substrate wherein at least a portion of the substrate is coated with a composition of the present disclosure.

Though the efficacy of quat-based compositions presented here is surprising against spores and non-enveloped viruses, the above composition does not exclude efficacy against enveloped viruses, which are easier to kill as opposed to non-enveloped viruses.

While specific embodiments are discussed, the specification is illustrative only and not restrictive. Many variations of this disclosure will become apparent to those skilled in the art upon review of this specification.

Unless defined otherwise, all technical and scientific terms used herein have the same meaning as is commonly understood by one of skill in the art to which this specification pertains.

As used in the specification and claims, the singular form “a”, “an” and “the” includes plural references unless the context clearly dictates otherwise.

As used herein, and unless otherwise indicated, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 50%, 20%, 15%, 10%, 9%, 8%, 7%, 6%, 5%, 4%, 3%, 2%, 1%, 0.5%, or 0.05% of a given value or range.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

The present disclosure will further be described by reference to the following examples. The following examples are merely illustrative and are not intended to be limiting.

### EXAMPLES

### Example 1—Sporicidal Efficacy

Spores were produced according to an adapted protocol defined in EPA MLB SOP MB-28: Procedure for the Production and Storage of Spores of Clostridium difficile for Use in the Efficacy Evaluation of Antimicrobial Agents. The anaerobic C. diff was substituted by B. subtilis, which is considered more resistant to sporicidal treatments. Disinfectant Formula (A) was prepared as outlined in Table 1.

TABLE 1
Formula (A)

| | Supplied | | |
|---|---|---|---|
| Material | Actives | ppm | wt % |
| Water | | | 96.49 |
| Organic acid | 25 | 2311 | 0.924 |
| Synthetic polymer | 20 | 800 | 0.4 |
| Quaternary ammonium | 50 | 1000 | 0.333 |
| compound (1) | | | |
| Quaternary ammonium | 50 | 4000 | 0.8 |
| compound (2) | | | |
| Amine oxide | 30 | 2700 | 0.9 |
| Chelating agent | 50 | 760 | 0.152 |
| Final pH 3.5 | | 1.1571 | <−Total % Act |

Formulation (A) was tested against B. Subtilis for sporicidal efficacy using a test adopted from EPA MLB SOP MB-31: Quantitative Method for Testing Antimicrobial Products Against Spores of Clostridium difficile (ATCC 43598) on Inanimate, Hard, Non-porous Surfaces. Bacillus subtilis (ATCC 19659) spores were developed on agar medium with pH adjusted to 7.0 and 8.5. The sporulation was confirmed microscopically with >90% yield. Each bar is an average±standard deviation of Log₁₀ Colony Forming Units (CFU) recovered from 4 replicate test carriers with exception to the control untreated bars with each being an average±standard deviation of Log₁₀ CFU of 3 replicate carriers. The contact time for each test was 10 minutes at room temperature.

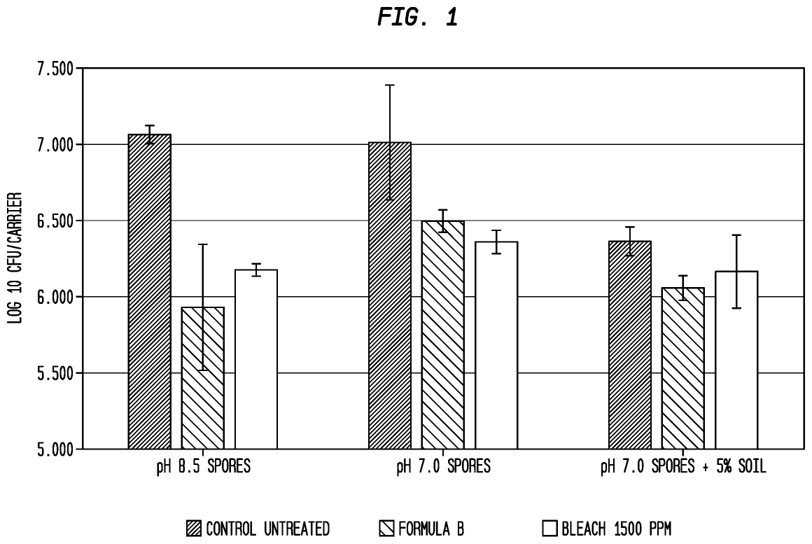

As a comparative example, B. subtilis shows minimal (<<0.5) log reduction at pH 3-4 with acidified ethanol. (See Nerandzic M M et al., “Unlocking the Sporicidal Potential of Ethanol: Induced Sporicidal Activity of Ethanol against Clostridium difficile and Bacillus Spores under Altered Physical and Chemical Conditions,” PLoS One. 2015. Jul. 15; 10(7):e0132805). The 0.5-1.0 log reduction at 10 minutes contact time with Formulation (A) is dramatically higher (FIG. 1). The pH denoted in FIG. 1 is the sporulation pH at which the bacillus spores were prepared. The formulation pH was acidic ˜3.5.

### Example 2—Virucidal Efficacy

Test formulations were prepared and their efficacy against enveloped and non-enveloped viruses was studied.

TABLE 2
Formula (B) (5,000 ppm quat)

| | Supplied | | | |
|---|---|---|---|---|
| Material | Actives | ppm | wt % | Grams |
| Water | | | 95.567 | 955.67 |
| Organic acid | 50 | 2500 | 0.500 | 5.00 |
| Synthetic polymer | 20 | 1600 | 0.800 | 8.00 |
| Amine oxide (1) | 30 | 1350 | 0.450 | 4.50 |
| Amine oxide (2) | 30 | 3100 | 1.033 | 10.33 |
| Chelating agent | 100 | 1500 | 0.150 | 1.50 |
| Non-ionic surfactant | 100 | 5000 | 0.500 | 5.00 |
| Quaternary ammonium | 50 | 2500 | 0.500 | 5.00 |
| compound (1) | | | | |
| Quaternary ammonium | 50 | 2500 | 0.500 | 5.00 |
| compound (2) | | | | |
| | | | 100 | 1000.00 |
| Initial pH 4.11 | | 2.005 | <−Total % Act | |
| Final pH 4.26 | | | | |

TABLE 3
Formula (C) (2,500 ppm quat)

| | Supplied | | | |
|---|---|---|---|---|
| Material | Actives | ppm | wt % | Grams |
| Water | | | 97.059 | 485.30 |
| Synthetic polymer | 50 | 1900 | 0.380 | 1.90 |
| Amine oxide (1) | 20 | 1600 | 0.800 | 4.00 |
| Amine oxide (2) | 30 | 1350 | 0.450 | 2.25 |
| Chelating agent | 30 | 1350 | 0.450 | 2.25 |
| Non-ionic surfactant | 100 | 1107 | 0.111 | 0.55 |
| Synthetic polymer | 100 | 2500 | 0.250 | 1.25 |
| Quaternary ammonium | 50 | 1250 | 0.250 | 1.25 |
| compound (1) | | | | |
| Quaternary ammonium | 50 | 1250 | 0.250 | 1.25 |
| compound (2) | | | | |
| | | | 100 | 500.00 |
| Initial pH 4.02 | | 1.2307 | <−Total % Act | |
| Final pH 4.02 | | | | |

Virucidal efficacy testing was performed at Analytical Lab Group-Midwest. All tests were conducted at room temperature with 5% bovine serum with contact time of 10 minutes. All cytotoxicity and neutralization control criteria were met for each viral test.

TABLE 4
Results

| Viral Strains | | Formula (B) | Formula (C) |
|---|---|---|---|
| Non- | Norovirus surrogate | 3.00 log | 1.50 log |
| enveloped | Feline Calicivirus, | reduction | reduction |
| | ATCC VR-782, | | |
| | Strain F-9 | | |
| | Human Rotavirus, | ≥4.00 log | ≥3.75 log |
| | ATCC VR-2018, | reduction | reduction |
| | Strain WA | | |

Long-Lasting Virucidal Efficacy

Formula B was further evaluated for long-lasting virucidal activity when applied to hard surfaces using standardized test protocols for residual disinfection such as RSD-12 (equivalent abrasions to RSS-24 under EPA guidance in October 2020) and PAS2424 described above. The tests were conducted with the bacteriophage Phi6, an enveloped virus, as a surrogate for human coronavirus for safely conducting the tests in a “Biosafety Level-2” (BSL-2) laboratory. Bacteriophages are commonly used as surrogates for human viruses, as they are similar in terms of size, shape, morphology, surface properties, mode of replication, and environmental persistence, yet are non-infectious to humans (only infecting bacteria such as Pseudomonas aeruginosa). Biocidal performance is measured in reduction in viral titer in the usual manner conducted by those skilled in the art.

Table 5 details the test results with Phi 6 (an enveloped viral surrogate) for long-lasting disinfection results for Formula B which shows that when formula B is applied to a surface it continues to provide protection against enveloped viruses (as the human coronavirus) for at least 12h with greater than 99.9% kill (>3 log reduction). The contact time for this study is 10 minutes. This is under the test guidance provided by the US-EPA pursuant to EPA Protocol #01-1A, adapted for viruses based on the EPA guidelines October 2020, and virucidal neutralization and efficacy in accordance with ASTM E1053.

TABLE 5
Residual 12 h disinfection performance with Phi 6 at 10 min.

| | | | | PFU/ | Log/ | | Log | Pass/ |
|---|---|---|---|---|---|---|---|---|
| | | Dilution | Count | surface | Surface | Average | reduction | fail |
| Control - | control 1 | 3 | 61 | 9.15E+06 | 6.96 | 6.92 | Passing is 3 log | |
| Triton X | control 2 | 3 | 51 | 7.65E+06 | 6.88 | | reduction or more | |
| Formula B | 1 | 0 | 1 | 1.50E+02 | 2.18 | 2.41 | 4.51 | PASS |
| | 2 | 0 | 3 | 4.50E+02 | 2.65 | | | |

Table 6 shows test results with Phi 6 (enveloped viral surrogate) with PAS2424 which is the standard test protocol published by the British Standards Institute. Formula B shows long-lasting sanitization according to PAS2424. When applied to a surface, Formula B continues to provide protection against enveloped viruses (as the human coronavirus) for at least 24 h with greater than 99.9% kill (>3 log reduction). The contact time for this study is 10 minutes.

TABLE 6
PAS2424 - 10 minute contact time. Inoculations with Phi6 in phage buffer + BSA.

| | | | | PFU/ | Log/ | | Log | Pass/ |
|---|---|---|---|---|---|---|---|---|
| | | Dilution | Count | surface | Surface | Average | reduction | fail |
| Control- | control 1 | 2 | 213 | 2.13E+06 | 6.33 | 6.40 | Passing is 3 log | |
| Hard Water | control 2 | 3 | 33 | 3.30E+06 | 6.52 | | reduction or more | |
| | control 3 | 2 | 221 | 2.21E+06 | 6.34 | | | |
| Formula B | 1 | 0 | 0 | <50 | <1.0 | <1.0 | >5.4 | PASS |
| | 2 | 0 | 0 | <50 | <1.0 | | | |
| | 3 | 0 | 0 | <50 | <1.0 | | | |
| | 4 | 0 | 0 | <50 | <1.0 | | | |
| | 5 | 0 | 0 | <50 | <1.0 | | | |

The disclosed subject matter has been described with reference to specific details of particular embodiments thereof. It is not intended that such details be regarded as limitations upon the scope of the disclosed subject matter except insofar as and to the extent that they are included in the accompanying claims.

Therefore, the exemplary embodiments described herein are well adapted to attain the ends and advantages mentioned as well as those that are inherent therein. The particular embodiments disclosed above are illustrative only, as the exemplary embodiments described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the exemplary embodiments described herein. The exemplary embodiments described herein illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components, substances and steps. As used herein the term “consisting essentially of” shall be construed to mean including the listed components, substances or steps and such additional components, substances or steps which do not materially affect the basic and novel properties of the composition or method. In some embodiments, a composition in accordance with embodiments of the present disclosure that “consists essentially of” the recited components or substances does not include any additional components or substances that alter the basic and novel properties of the composition. If there is any conflict in the usages of a word or term in this specification and one or more patent or other documents that may be incorporated herein by reference, the definitions that are consistent with this specification should be adopted.

What is claimed is:

1. A method for killing pathogens on a surface, the method comprising applying a composition to the surface, the composition comprising:
a. at least one quaternary ammonium compound;
b. a polymer comprising one or more types of monomer units selected from the group consisting of cationic monomer units, anionic monomer units, amphoteric monomer units, non-ionic monomer units, and combinations thereof, wherein at least one cationic monomer unit, at least one amphoteric monomer unit or at least one anionic monomer unit is present when the polymer comprises one or more non-ionic monomer units;
c. a surfactant selected from the group consisting of cationic surfactants, amphoteric surfactants, non-ionic surfactants, and combinations thereof; and
d. optionally, an organic acid,
wherein the pH of the composition is less than 5; and the composition achieves at least 0.5 log reduction in the amount of live pathogens on the surface, wherein the pathogens are selected from the group consisting of bacterial spores, fungal spores, non-enveloped viruses and combinations thereof within about 60 minutes, under conditions of standard temperature and pressure.

2. The method of claim 1, wherein the composition achieves at least 3 log reduction in the amount of live pathogens within about 60 minutes, under conditions of standard temperature and pressure.

3. The method of claim 1, wherein the composition achieves at least 3 log reduction in the amount of live pathogens within about 30 minutes, under conditions of standard temperature and pressure.

4. The method of claim 1, wherein the composition achieves at least 3 log reduction in the amount of live pathogens within about 10 minutes, under conditions of standard temperature and pressure.

5. The method of claim 1, wherein the pathogens are selected from the group consisting of bacterial spores.

6. The method of claim 1, wherein the pathogens are selected from the group consisting of fungal spores.

7. The method of claim 1, wherein the pathogens are selected from the group consisting of non-enveloped viruses.

8. The method of claim 1, wherein the quaternary ammonium compound is selected from the group consisting of monoalkyldimethylbenzyl ammonium salts, dialkyldimethyl ammonium salts, and combinations thereof.

9. The method of claim 1, wherein the polymer comprises only cationic monomer units.

10. The method of claim 1, wherein the polymer comprises only anionic monomer units.

11. The method of claim 1, wherein the composition further comprises an organic acid selected from the group consisting of citric, malic, maleic, lactic, succinic, glutaric, adipic acids and combinations thereof.

12. The method of claim 1, wherein the surfactant is selected from the group consisting of alkyl amines, ethoxylated alkyl amines, cationic amine oxides, and combinations thereof.

13. The method of claim 1, wherein the surfactant is selected from the group consisting of betaines.

14. The method of claim 1, wherein the surfactant is selected from the group consisting of alcohol ethoxylates.

15. The method of claim 1, wherein the composition further comprises an additive selected from the group consisting of polar carrier solvents, chelating agents, fragrances, preservatives, dyes, corrosion inhibitors, builders, cleansing solvents, and combinations thereof.

16. The method of claim 1, wherein the surface comprises a substrate selected from plastic, laminate, metal, glass, ceramic tile, paper, fabric, finished wood, unfinished wood, and combinations thereof.

17. The method of claim 1, wherein the composition is applied to the surface by spraying, pouring, wiping, or mopping.

18. The method of claim 1, wherein the composition further comprises at least one germinant in an amount sufficient to initiate germination of bacterial spores present on the surface.

19. The method of claim 1, wherein the composition further comprises an additive selected from the group consisting of ethanolamines, amino acids, thio-alcohols, thiolamines, and combinations thereof.

20. The method of claim 1 further comprising the step of treating the surface using a technique selected from the group consisting of ultrasonication, filtration, UV irradiation, heating, freezing, drying, and combinations thereof.
